(19) United States
(12) Patent Application Publication
(10) Pub. No.: US 2018/0024749 A1
(43) Pub. Date: Jan. 25, 2018

(54) INFORMATION PROCESSING APPARATUS, NON-TRANSITORY COMPUTER-READABLE RECORDING MEDIUM HAVING STORED THEREIN PROGRAM, AND METHOD FOR PROCESSING INFORMATION

(71) Applicant: FUJITSU LIMITED, Kawasaki-shi (JP)

(72) Inventors: Hirokazu OHTA, Edogawa (JP); NOBUAKI SASAKI, Setagaya (JP); Kazunari YONEYA, Sagamihara (JP)

(73) Assignee: FUJITSU LIMITED, Kawasaki-shi (JP)

(21) Appl. No.: 15/612,407

(22) Filed: Jun. 2, 2017

(30) Foreign Application Priority Data
Jul. 25, 2016 (JP) 2016-145318

(51) Int. Cl. G06F 3/06; G06F 13/16

(52) U.S. Cl. CPC G06F 3/0608; G06F 3/0644; G06F 13/1663; G06F 3/065; G06F 3/0685; G06F 3/0635

(57) ABSTRACT

An information processing apparatus includes: a first calculator and a second calculator being coupled to each other via a bus, and each making a memory access, designating a logical address; a first memory being coupled to the first calculator; and a second memory being coupled to the second calculator and being accessed from the first calculator via the bus, wherein the first memory determines, based on a time from issue of a request for the memory access to response to the request, whether a memory having a physical address associated with the logical address is the first memory or the second memory. With this configuration, it is possible to specify whether a memory being accessed using a logical address is a local memory or a remote memory.

### CROSS-REFERENCE TO RELATED APPLICATION

This application is based upon and claims the benefit of priority of the prior Japanese Application No. 2016-145318 filed on Jul. 25, 2016 in Japan, the entire contents of which are hereby incorporated by reference.

### FIELD

The embodiments disclosed herein is related to an information processing apparatus, a non-transitory computer-readable recording medium having stored therein a program, and a method for processing information.

### BACKGROUND

In a multiprocessor device including multiple processors, the processors are connected to one another via a bus and each connected to a memory. Here, a memory connected to one of the processors and directly accessed from the processor is referred to as the “local memory” of the processor. In contrast, a memory connected to another processor and accessed from the processor via the bus and/or other processor(s) is referred to as a “remote memory” of the processor.

In such a multiprocessor device, a test program that operates on the Operating System (OS) of the device is sometimes executed in order to test paths including the bus between processors during the evaluating and manufacturing processes.

[Patent Literature 1] Japanese Laid-open Patent Publication No. 2009-48343

[Patent Literature 2] Japanese Laid-open Patent Publication No. 2001-356971

In a path test, each processor accesses the memories, designating the respective logical addresses of the memories. For this purpose, the OS allocates data, using the logical addresses of the memory, so that each processor is not able to specify the physical position of a memory to be accessed, which means that the processor is not able to specify whether the memory to be accessed is a local memory or a remote memory. Accordingly, the path test takes a long time because each processor accesses all the memories to forward data through all the paths between the processors.

### SUMMARY

According to an aspect of the embodiments, an information processing apparatus includes: a first calculator and a second calculator being coupled to each other via a bus, and each making a memory access, designating a logical address; a first memory being coupled to the first calculator; and a second memory being coupled to the second calculator and being accessed from the first calculator via the bus, wherein the first memory determines, based on a time from issue of a request for the memory access to response to the request, whether a memory having a physical address associated with the logical address is the first memory or the second memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating paths through which each processor accesses to a local memory and remote memories in a multiprocessor apparatus;

FIG. 2 is a diagram illustrating paths to be subjected to a path test carried out a traditional test program in a multiprocessor apparatus of FIG. 1;

FIG. 3 is a diagram illustrating distances between a processor and local/remote memories in a multiprocessor apparatus of FIG. 1;

FIG. 4 is a graph denoting a relationship between an access speed and logical addresses of local/remote memories on the basis of the distances of FIG. 3;

FIG. 5 is a diagram illustrating paths to be subjected to a path test according to a present embodiment;

FIG. 6 is a block diagram schematically illustrating the hardware configuration of an information processing apparatus of the present embodiment;

FIG. 7 is a diagram illustrating the functional configuration of an information processing apparatus and its basic operation of the present embodiment;

FIGS. 8A and 8B are a flow diagram illustrating a succession of procedural steps performed in an information processing apparatus (multiprocessor apparatus) of the present embodiment;

FIGS. 9A and 9B are diagrams illustrating examples of an association table of the present embodiment;

FIG. 10 is a diagram illustrating an example of a position table of the present embodiment; and

FIG. 11 is a diagram illustrating an example of a test path pattern table of the present embodiment.

### DESCRIPTION OF THE PREFERRED EMBODIMENTS

Hereinafter, an embodiment of an information processing apparatus, a non-transitory computer-readable recording medium having stored therein a program, and a method for processing information disclosed in this patent application will now be described with reference to the accompanying drawings. The following embodiments are exemplary, so there is no intention to exclude applications of various modifications and techniques not explicitly described in the following description to the embodiment. The accompanying drawings of the embodiments do not limit that the elements appearing therein are only provided but can include additional functions. The embodiments can be appropriately combined as long as no contradiction is incurred.

(1) Related Technique:

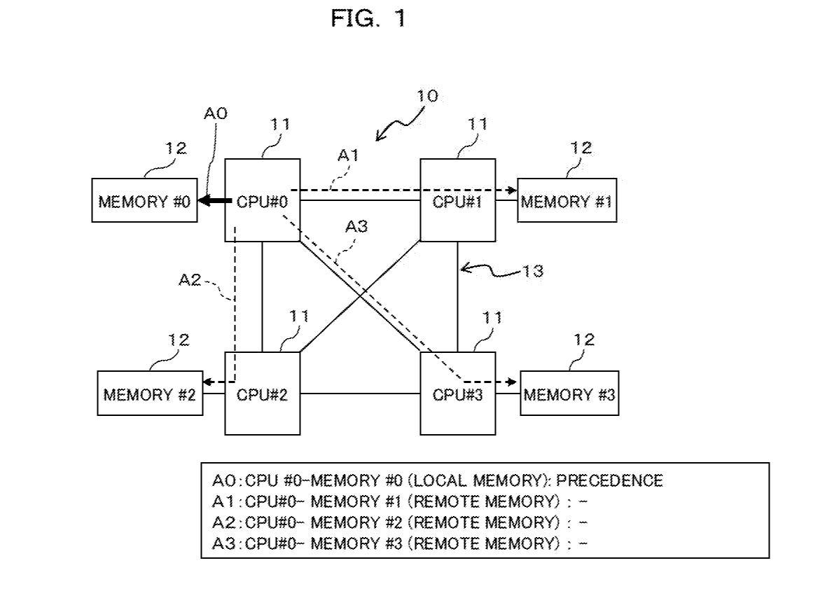

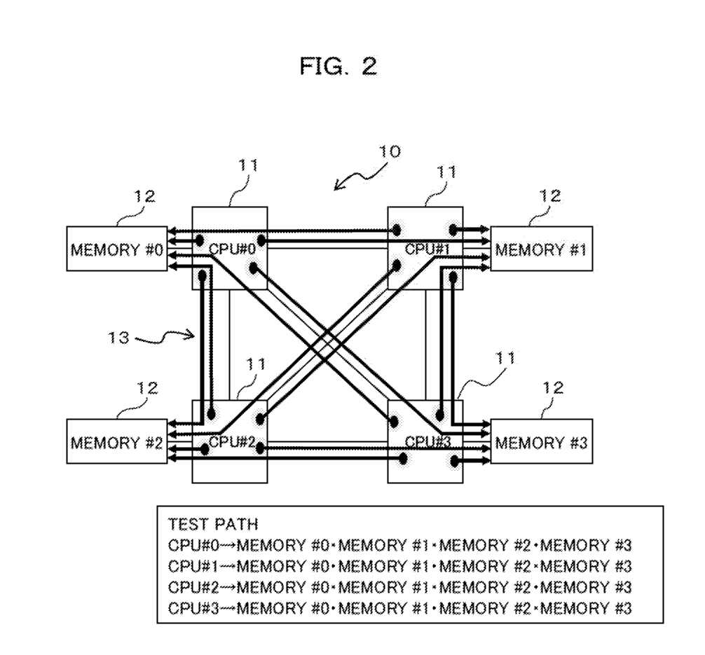

First of all, a technique (hereinafter, referred to as the “related technique”) related to the present patent application will now be described with reference to FIGS. 1 and 2. FIG. 1 is a diagram illustrating paths through which each processor accesses to a local memory and remote memories in a multiprocessor apparatus 10; and FIG. 2 is a diagram illustrating paths to be subjected to a path test carried out a traditional test program in the multiprocessor apparatus 10 of FIG. 1.

In the following examples to be described with reference to FIGS. 1-3 and 5-7, the multiprocessor device 10 is assumed to be a four-socket CPU having four Central Processing Units (CPUs) each corresponding to a processor or a calculator. An arbitrary CPU among the four CPUs is represented by a reference number 11, but a specified CPU among the four CPUs 11 is represented by a notation CPU #i (wherein i=0, 1, 2, 3). The serial number “i” can be regarded as an identification number to specify each CPU 11.

In the multiprocessor device 10, the four CPUs 11 is coupled to one another via, for example, a crossbar switch 13 including a bus, and a memory 12 is coupled to each CPU 11. The crossbar switch 13 is sometimes referred to as a bus 13. An arbitrary memory among the four memories is represented by a reference number 12, but a specified memory among the four memories 12 is represented by notation memory #i (wherein i=0, 1, 2, 3). The serial number “i” can be regarded as an identification number to specify each memory 12. To the CPU #i, the memory #i is directly coupled.

The multiprocessor device 10 may include two, three, five or more CPUs 11, which means the number of CPUs 11 is not limited to four. The same is applied to the number of memories 12.

As illustrated in FIG. 1, the memory #0, which is coupled to the CPU #0 and is also directly accessed from the CPU #0, is referred to as the “local memory” of the CPU #0 (see Arrow A0). In contrast, the memories #1-#3, which are coupled to the CPUs #1-3, respectively, and which are also accessed from the CPU #0 via the bus 13 are referred to as the “remote memories” of the CPU #0 (see Arrows A1-A3).

Likewise, the local memory of the CPU #1 is the memory #1 and the remote memories of the CPU #1 are memories #0, #2, #3; the local memory of the CPU #2 is the memory #2 and the remote memories of the CPU #2 are memories #0, #1, #3; and the local memory of the CPU #3 is the memory #3 and the remote memories of the CPU #3 are memories #0, #1, #2.

Normally, when a test program that operates on the OS is to be executed, the test program dynamically reserves a test region in the memory 12. Specifically, the test program causes the memory controller or the scheduler of the OS to preferentially reserve the test region in the local memory of each CPU 11. This is because preferentially securing a test region in a remote memory is not usual and therefore it is difficult to forward data through the path between CPUs to be used to access a remote memory. For example, as illustrated in FIG. 1, when the OS is to dynamically reserve a test region from the CPU #0 in the multiprocessor device 10 having a four-sockets CPU, a test region is preferentially reserved from the memory #0, which is the local memory of the CPU #0.

Providing that each CPU 11 includes a local memory having a capacity of 8 gigabytes (GB) installed therein, the CPU 11 needs a memory capacity of 4 GB to cause the CPU core in the CPU 11 to accomplish a floating-point arithmetic using the data size of 256 megabytes (MB). The memory capacity of 4 GB for the arithmetic is within 8 GB, which is the capacity of the local memory. This eliminates the need for access to a remote memory. If the data size to be used is increased, an access to a remote address is to be made. However, since the OS allocates data, using the logical addresses of the respective memories 12, each CPU is not able to grasp the physical position of a memory to be accessed. This means that the CPU 11 is not able to specify whether the memory to be accessed is a local memory or a remote memory.

Consequently, each CPU 11 needs to access all the memories 12 to forward data to all the inter-CPU paths, and it takes a long time to accomplish such a path test. For example, the four-socket CPU of FIG. 2 has 16 test paths for the traditional test program (see thick arrows). Accordingly, assuming that each path takes one hour to accomplish the reading/writing test to a memory, it takes 16 hours to accomplish the test on all the 16 paths.

Recent increase in speed and in scale of a server demands an overall path test on the inter-CPU paths, but such a path test takes a remarkable long time as described above.

Besides, since a path test burdens the inter-CPU paths, a problem such as a one-bit error occurs during actual operation. This problem is caused for the reason that an overall path test on the inter-CPU paths has not been carried out for taking a remarkable long time to accomplish such an overall path test.

(2) Overview of the Present Embodiment:

As a solution to the above, the present embodiment makes it possible to specify an inter-CPU path (path route) by a scheme that can specify whether a memory to be accessed using a logical address is a local memory or a remote memory. This avoids execution of the test on a redundant path, but paths that need test surely undergo the path test without carrying out an overall path test, so that the path test can be accomplished in shorter time (i.e., efficiently).

In the present embodiment, on the basis of a time that each CPU 11 under control of the OS takes to access each memory 12, designating the logical address, a determination is made as to whether the memory 12 associated with the logical address is a local memory or a remote memory. In the event of the path test, each CPU 11 makes an access to a remote memory, designating the logical address based on the result of the determination.

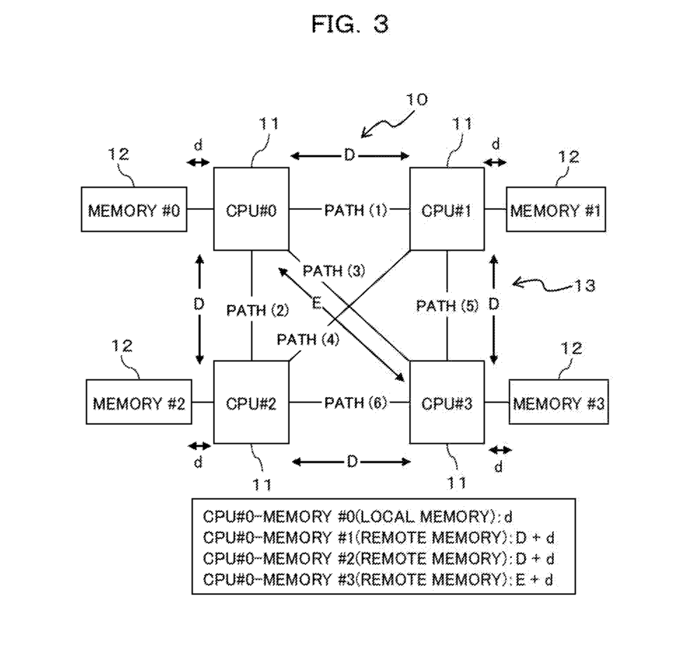

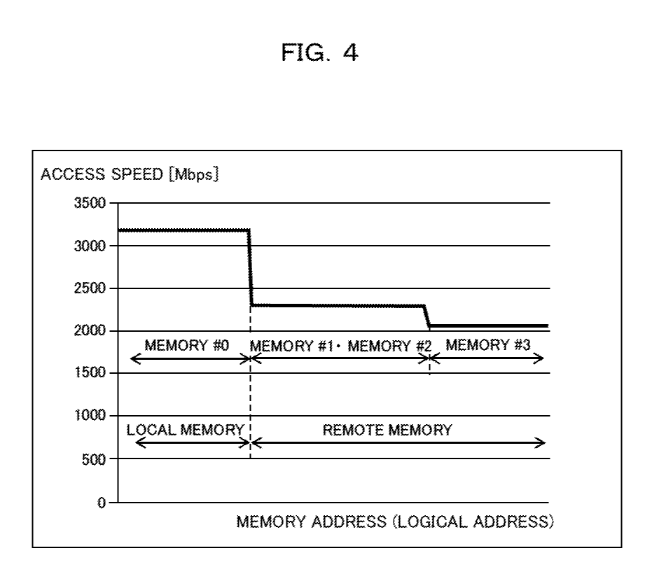

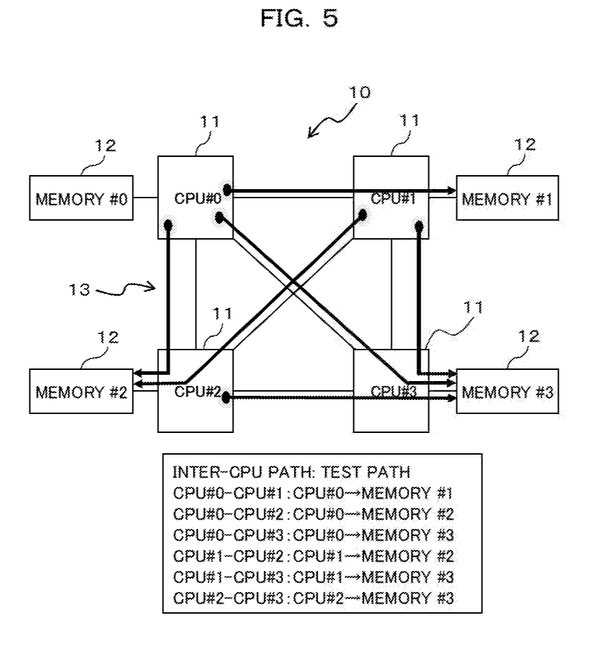

Description will now be made in relation to the overview of the present embodiment with reference to FIGS. 3-5. FIG. 3 is a diagram illustrating distances between a processor (CPU #0) and a local/remote memories (memories #0-#3) in the multiprocessor apparatus 10 of FIG. 1; FIG. 4 is a graph denoting a relationship between an access speed and logical addresses of local/remote memories on the basis of the distances of FIG. 3; and FIG. 5 is a diagram illustrating paths (path patterns) to be subjected to a path test according to a present embodiment.

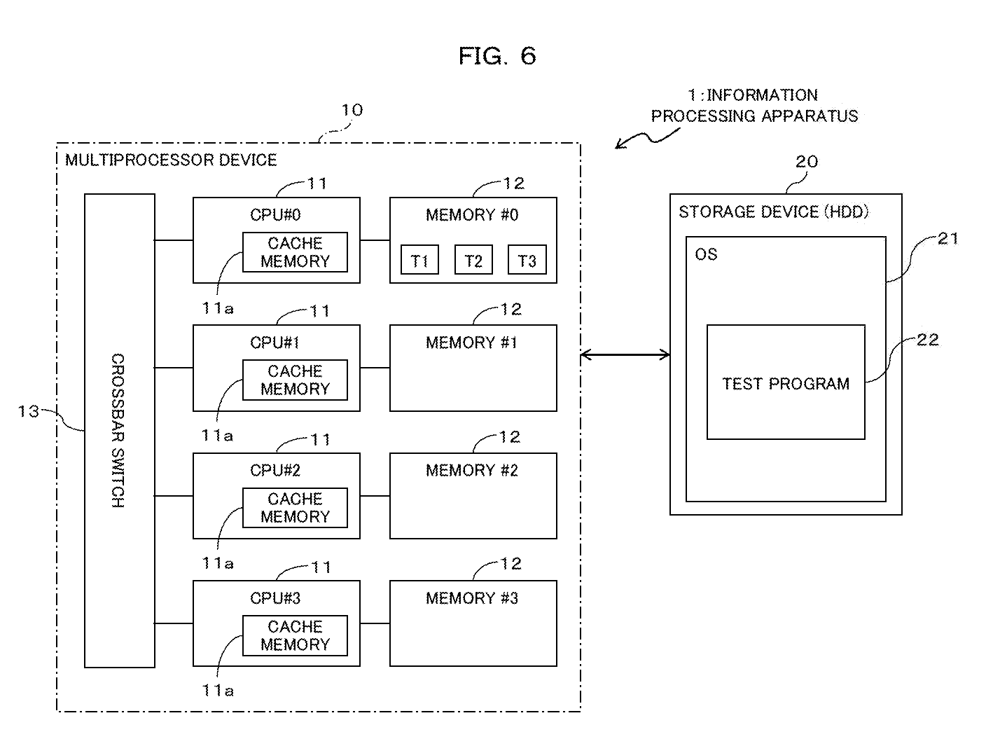

In the present embodiment, the program to be applied the technique of the present embodiment is assumed to be a program that operates on the OS of the multiprocessor device 10. Information about the number of CPUs 11, the size of a cache memory 11a (see FIG. 6) of each CPU 11, and a capacity of each memory is assumed to be obtainable from the OS or a device managing unit of the multiprocessor device 10. The process of executing the present test program is assumed to be a process of evaluating or manufacturing the present multiprocessor device 10.

The path test to be applied the technique of the present embodiment is roughly divided into two steps of a first step and a second step.

The first step associates the logical address of each memory 12 with the physical position of the memory 12 on the basis of a time taken to access the memory 12 being made, designating the logical address. In other words, the first step determines whether each memory 12 is a local memory or a remote memory.

The second step generates path patterns of the inter-CPU paths to be subjected to the path test on the basis of the result of determination (association) obtained in the first step, and carries out the path test according to the generated path patterns.

In the first step, each CPU 11 makes memory accesses to the entire regions of memories 12, designating a logical address of each unit block (unit data size) of a predetermined size. The number of CPUs 11 and the capacity of each memory 12 are grasped beforehand. Consequently, an access time that each memory access takes or an access speed (=size of unit block/access time) based on the access time is measured and obtained.

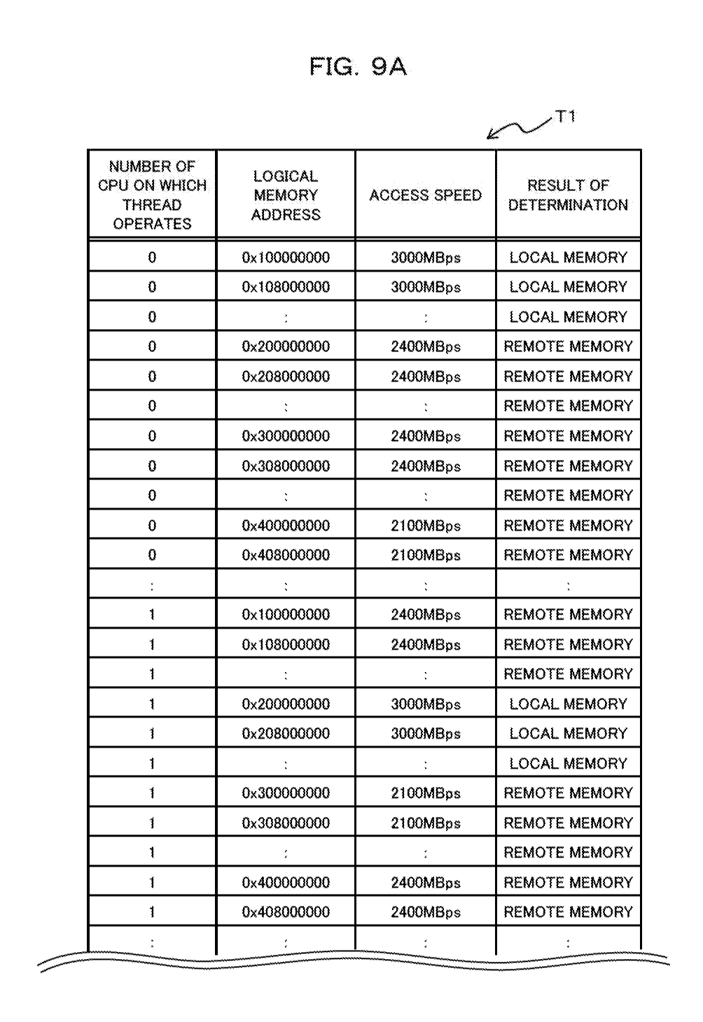

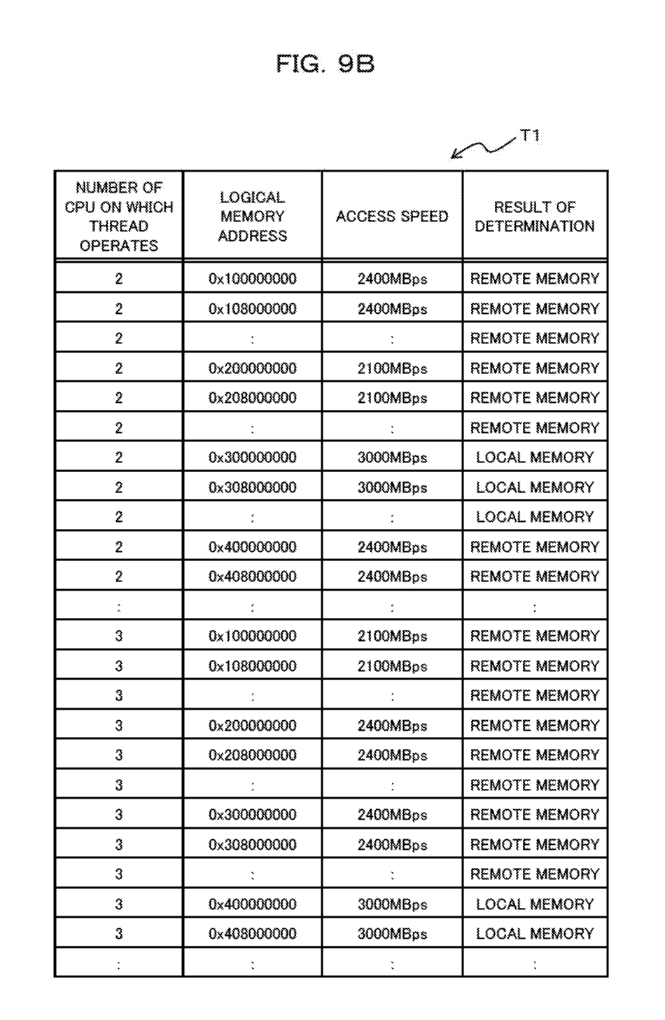

In the illustrated example, an access speed is assumed to be obtained. Each CPU 11 determines that a memory region having the fastest access speed is the region of the local memory and the remaining memory regions are the regions of the remote memories. In addition, an association table T1 (first table, see FIGS. 9A and 9B) in which a logical address is associated with the result of determination of local memory/remote memory of each CPU 11 is generated.

In cases where an access time is obtained in place of an access speed, each CPU 11 determines that a memory region having the shortest access time is the region of the local memory and the remaining memory regions are the regions of the remote memories. In addition, a table (first table) similar to the above association table T1 is generated.

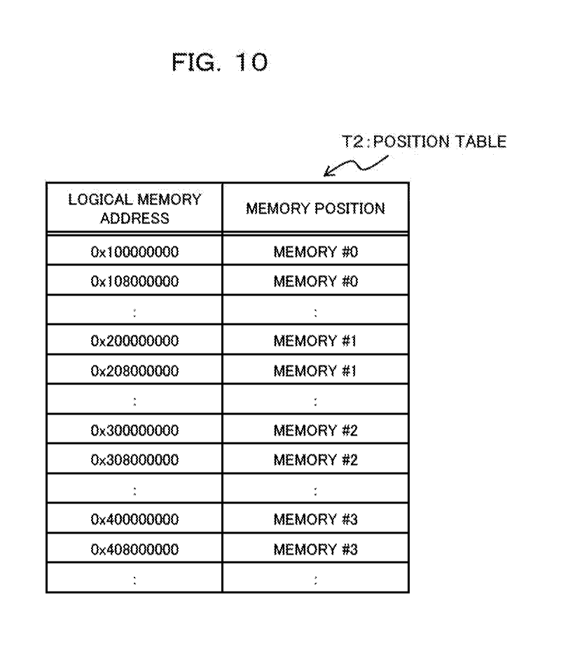

Then, in the first step, the position (physical position) of a memory 12 is determined from the logical address associated with the local memory installed in (coupled to) each CPU 11, and a position table T2 (second table, see FIG. 10) representing an association of the logical address with each memory 12 is generated.

Normally, a remote memory of a CPU 11 is positioned physically farer to the CPU 11 than a distance from the local memory to the CPU 11. In other words, the distance from the CPU 11 to a remote memory is longer than the distance from the CPU 11 to its local memory. In the four-socket CPU as illustrated in FIG. 3, a distance between the CPU #i and the memory #i is d; the distance between the CPU #0 and the CPU #1 (the length of the path (1)), the distance between the CPU #0 and the CPU #2 (the length of the path (2)), the distance between the CPU #1 and the CPU #3 (the length of the path (5)), and the distance between the CPU #2 and the CPU #3 (the length of the path (6)) are each D (>d); and the distance between the CPU #0 and the CPU #3 (the length of the path (3)) and the distance between the CPU #1 and the CPU #2 (the length of the path (1)) are each E (>D). With this configuration, the distance between the CPU #0 and the memory #0 is d; the distance between the CPU #0 and the memory #1 is D+d; the distance between the CPU #0 and the memory #2 is D+d; and the distance between the CPU #0 and the memory #3 is E+d.

Accordingly as illustrated in FIG. 4, as a result of memory accesses from a CPU 11, designating the logical addresses, the memory having the fastest access speed, which means the shortest access time, is determined to be the local memory of the CPU 11. The remaining memories are determined to be the remote memories of the CPU 11.

The predetermined size (unit data size) of the unit block is set to a value larger than the cache size in order to avoid cache hit in the cache memory 11a. This is because occurrence of a cache hit impedes access to a memory 12 to make it impossible to measure an access time and an access speed.

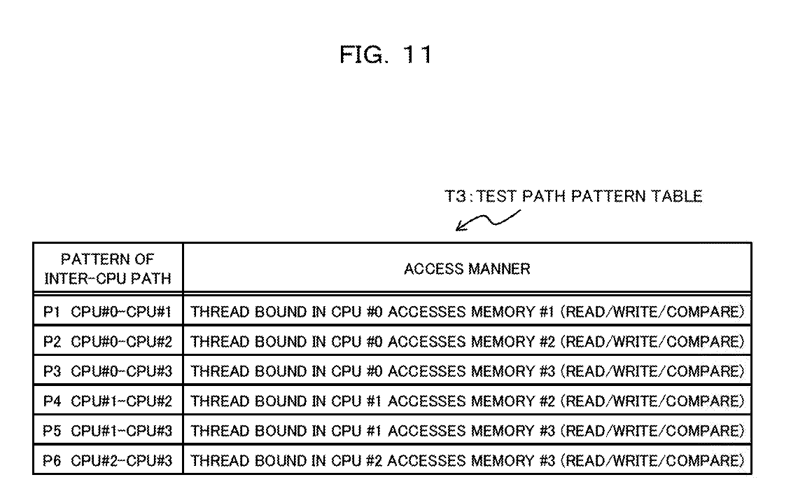

The second step generates path patterns (test path pattern table T3, see FIG. 11) in the following procedures of (a1), (a2), and (a3) on the basis of the position table T2 obtained in the above first step.

(a1) Paths from a CPU having a smallest number to all the remote memory are selected. Here, the CPU having a smallest number is a CPU having the smallest identification number (serial number) that identifies the CPU 11 and corresponds to the CPU #0 in the example of FIG. 5.

(a2) Among the paths from a CPU having a second smallest number to all the remote memory, paths except for the paths selected in above procedure (a1) are selected. The CPU having the second smallest number to the CPU #0 is the CPU #1. Similarly, the CPU having the next smaller number to the CPU #1 is the CPU #2; and the CPU having the next smaller number to the CPU #2 is the CPU #3.

(a3) Procedure (a2) is carried out on all the CPUs 11.

For example, the above procedure (a1)-(a3) of the present test program selects six test paths for the test path patterns from the four-socket CPU as illustrated in FIG. 5. As the result of these procedures, the test path pattern table T3 (see FIG. 11) is generated.

The present embodiment clarifies the logical addresses of the memories 12 to be accessed in the above manner, so that data forwarding through the respective paths can be executed in parallel with one another. This can greatly reduce the time for the path test on the inter-CPU paths.

In cases where eight-GB memories 12 are installed, as local memories, in a four-socket CPU, the above first step that determines whether each memory is a local memory or a remote memory takes about 54 seconds. Assuming that a reading/writing test through each path to a memory 12 takes one hour, the above second step takes one hour for testing the six paths because the test on the six paths can be carried out in parallel to one another. This means that the time for testing inter-CPU path can be reduced by 15 hours.

As described above, the present embodiment can largely reduce the time for overall path test on the inter-CPU paths carried out in the step of evaluating or manufacturing a device such as a server system. In addition, being not able to specify the physical position of each memory 12, the above related technique is not able to intentionally apply load onto a particular inter-CPU path. In contrast, the present embodiment can intentionally apply load on a particular inter-CPU path or can specify a failure inter-CPU path by accessing a memory 12 physical positions of which is specified.

(3) Hardware Configuration of the Present Embodiment:

Description will now be made in relation to the hardware configuration of the information processing apparatus 1 according to the present embodiment with reference to FIG. 6. FIG. 6 is a block diagram illustrating the hardware configuration of the information processing apparatus 1. As illustrated in FIG. 6, the information processing apparatus 1 of the present embodiment includes at least a multiprocessor device 10 and a storage device 20.

As described above, the multiprocessor device 10 of the present embodiment is a four-socket CPU having four CPUs 11 each corresponding to a processor or a calculator. The four CPUs 11 are coupled to one another via a crossbar switch (bus) 13, and each CPU 11 is coupled to a single memory 12 (local memory) installed therein. In the present embodiment, the local memory #0 of the CPU #0 having the smallest number reserves a region to store tables T1-T3 (FIGS. 9A-11) as to be detailed below. Alternatively, the tables T1-T3 may be stored in another memory 12 except for the memory #0 or in the storage device 20.

To the multiprocessor device 10, the storage device 20 is connected. The storage device 20 stores various programs for various processes to be performed by the CPU 11. It is sufficient that the storage device 20 includes at least one of a Read Only Memory (ROM), a Random Access Memory (RAM), a Storage Class Memory (SCM), a Solid State Drive (SSD), and a Hard Disk Drive (HDD). The present embodiment assumes that the storage device 20 is an HDD.

The Various program includes an OS program (hereinafter simply called OS) 21 that operates on the CPU 11 of the multiprocessor device 10, and an application program, such as a test program 22 of the present embodiment that operates on the OS 21.

The application program such as the test program 22 may be stored in a non-transitory portable recording medium exemplified by an optical disk, a memory device, and a memory card. A program stored in such a portable recording medium comes to be executable after being installed into the memory 12 under control of the CPU 11, for example. Alternatively, the CPU 11 may directly read the program from the portable recording medium and execute the read program.

An optical disk is a non-transitory portable recording medium in which data is readably recorded by utilizing optical reflection. Examples of an optical disk are a Blue-ray Disc™, a Digital Versatile Disc (DVD), a DVD-RAM, a Compact Disc Read Only Memory (CD-ROM), and a CD-R(Recordable)/RW(ReWritable). A memory device is a non-transitory recording medium having a communication function with a device connecting interface, and is exemplified by a Universal Serial Bus (USB) memory. A memory card is a card-type non-transitory recording medium that comes to be a target of reading and writing data when being connected to the test program 22 via a memory reader/writer.

The information processing apparatus 1 may further include the following inputting device, a display, and various interfaces in addition to the multiprocessor device 10 and the HDD 20. An example of the input device is a keyboard and a mouse which are operated by the user to make instructions to the CPU 11. The mouse may be replaced with a touch panel, a tablet device, a touch pad, or a track ball. An example of the display is a monitor display using a Cathode Ray Tube (CRT) and a Liquid Crystal Display (LCD), and outputs information related to various processes for displaying. In addition to the display, there may be installed an output device that prints information related to various processes. The various interfaces may include an interface for a cable or a network that connects an external peripheral device to the information processing apparatus 1 for data transmission and reception.

(4) Functional Configuration and Basic Operation of the Present Embodiment:

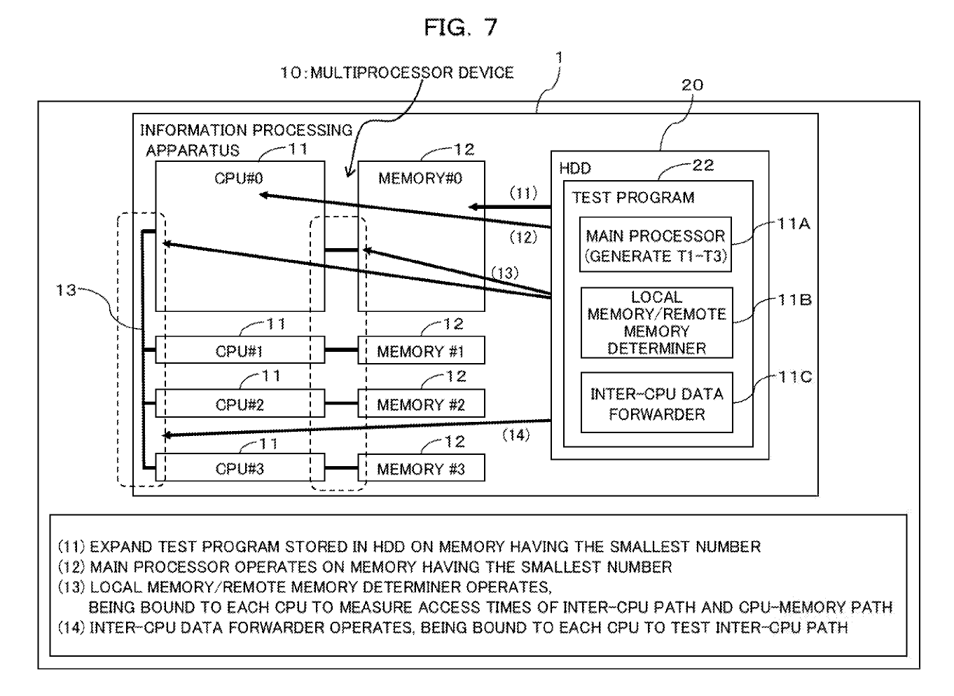

Here, description will now be made in relation to the functional configuration and the basic operation of the information processing apparatus 1 of the present embodiment with reference to FIG. 7. FIG. 7 illustrates the functional configuration and the basic operation of the information processing apparatus 1. As illustrated in FIG. 7, the test program 22 of the present embodiment causes each CPU 11 (first calculator) to function as a main processor 11A, a local memory/remote memory determiner 11B, and an inter-CPU data forwarder 11C. This means that each CPU (first calculator) functions as the main processor 11A, the local memory/remote memory determiner 11B, and the inter-CPU data forwarder 11C by executing the test program 22 of the present embodiment.

The information processing apparatus 1 of the present invention carries out the basic operation indicated by Arrows (11)-(14) in FIG. 7. The operations of Arrows (12)-(14) are achieved by the functions of the main processor 11A, the local memory/remote memory determiner 11B, and the inter-CPU data forwarder 11C, respectively. The operations of Arrows (11)-(13) are included in the above first step and the operation of Arrow (14) is included in the above second step.

The operation of Arrow (11): the test program 22 stored in the HDD 20 is expanded in the memory #0, which has the smallest number.

The operation of Arrow (12): the main processor 11A operates on the smallest-number CPU #0 by the smallest-number CPU #0 executing the test program 22 expanded in the smallest-number memory #0, which accompanies generating and storing the tables T1-T3 on the smallest-number memory #0.

The operation of Arrow (13): the local memory/remote memory determiner 11B operates, being bound to each CPU 11, by the smallest-number CPU #0 executing the test program 22 expanded in the smallest-number memory #0. At this time, access times or access speeds of the inter-CPU paths and the CPU-memory paths are measured, and on the basis of the result of the measurement, discrimination between a local memory and a remote memory is made for each CPU 11.

The operation of Arrow (14): the inter-CPU data forwarder 11C operates, being bound each CPU 11, by the smallest-number CPU #0 executing the test program 22 expanded in the smallest-number memory #0, and thereby tests the inter-CPU paths.

Hereinafter, detailed description will now be made in relation to the functions of the main processor 11A, the local memory/remote memory determiner 11B, and the inter-CPU data forwarder 11C of each CPU 11. The local memory/remote memory determiner 11B is sometimes abbreviated to the determiner 11B.

For local/remote memory determination, the CPU 11 (first calculator, smallest-number CPU #0) of the present embodiment measures a time from issue of a request for memory access to a memory 12 to receipt of the response to the request. Here, memory access to a memory 12 is issued, designating the logical address. On the basis of the measured time (access time or access speed), the memory 12 having a physical address associated with the logical address is determined to be a local memory (first memory) or a remote memory (second memory).

In this event, the main processor 11A reserves a region to store the tables T1-T3 (FIGS. 9A-11) on the local memory #0 of the smallest-number CPU #0.

The local memory/remote memory determiner 11B divides the entire regions of all the memories 12 into unit blocks each having a predetermined size, and obtains a time taken for a memory access to each unit block accomplished by designing the logical address associated with the unit block. As described above, the predetermined size of a unit block is set to be larger than the size of the cache memory 11a of the CPU 11.

If making the determination based on the access time, the determiner 11B stores each logical address and an access time in the association table T1 in association with each other. Among the logical addresses stored in the association table T1, the determiner 11B recognizes the logical address associated with an access time shorter than access times associated with other logical addresses as a first logical address. The determiner 11B determines a memory 12 having a first physical address associated with the first logical address to be the local memory.

If making the determination based on the access speed, the determiner 11B calculates the access speed from the obtained access time and the predetermined size of the unit block, and stores each logical address and the access speed in the association table T1 in association with each other. Among the logical addresses stored in the association table T1, the determiner 11B recognizes the logical address associated with an access speed faster than access speeds associated with other logical addresses as a first logical address. The determiner 11B determines a memory 12 having a first physical address associated with the first logical address to be the local memory.

The determiner 11B recognizes the other logical addresses as second addresses and determines the memories 12 having second physical addresses associated with the second logical addresses to be the remote memories 12.

On the basis of the result of associating each logical address with an access time or an access speed in the association table T1, the main processor 11A generates a position table T2 that specifies an association of a first logical address or a second logical address with a local memory and a remote memory. Specifically, the main processor 11A specifies the physical position of a memory 12 on the basis of a logical address (see table T1) associated with the local memory connected or installed in each CPU 11 and generates the position table T2 that stores the association between a logical address and a memory position.

The inter-CPU data forwarder 11C carries out a path test on an inter-CPU path on the basis of the position table T2. For this purpose, the main processor 11A generates a test path pattern table T3 (see FIG. 11) that stores path patterns of the combination of CPU #i and CPU #j (where j=0, 1, 2, 3; and i<j). The CPU #i carries out the path test for the memory #j (the memory to the home node) of the CPU #j while the CPU #j does not carry out the path test for the memory #i of the CPU #i. The going path from the CPU #i to the CPU #j is checked by a writing command while the returning path is checked by a reading command. The inter-CPU data forwarder 11C carries out, on the basis of the test path pattern table T3, the test of each memory and data forwarding between CPUs accompanied by the executing of the test in parallel with each other.

(5) Operation of the Present Embodiment:

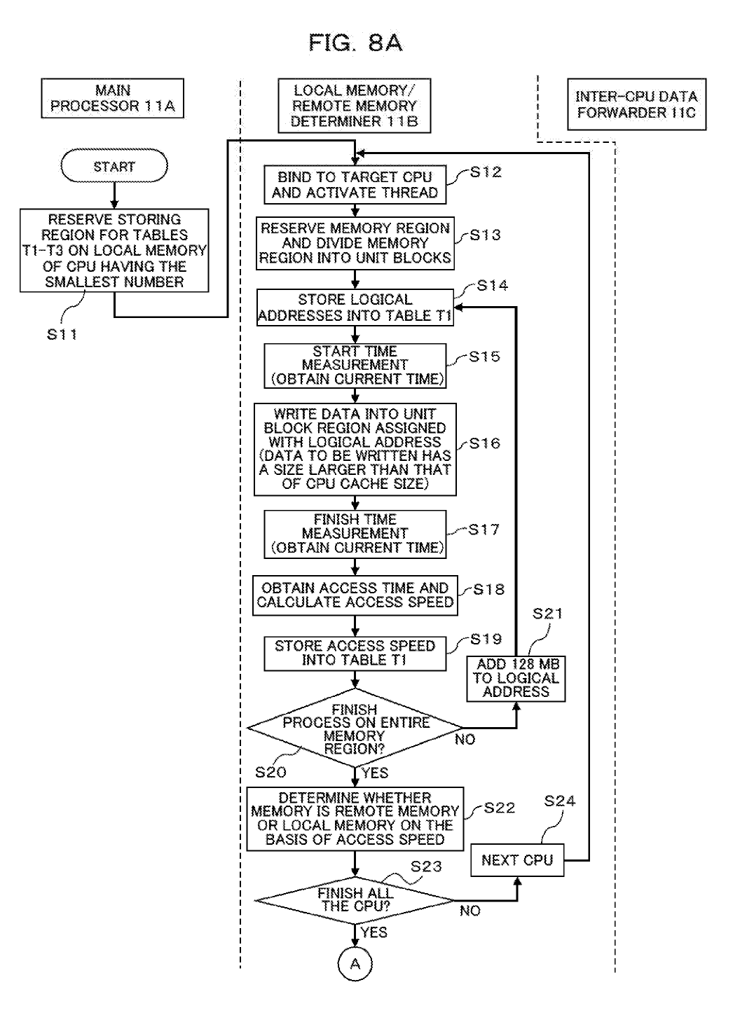

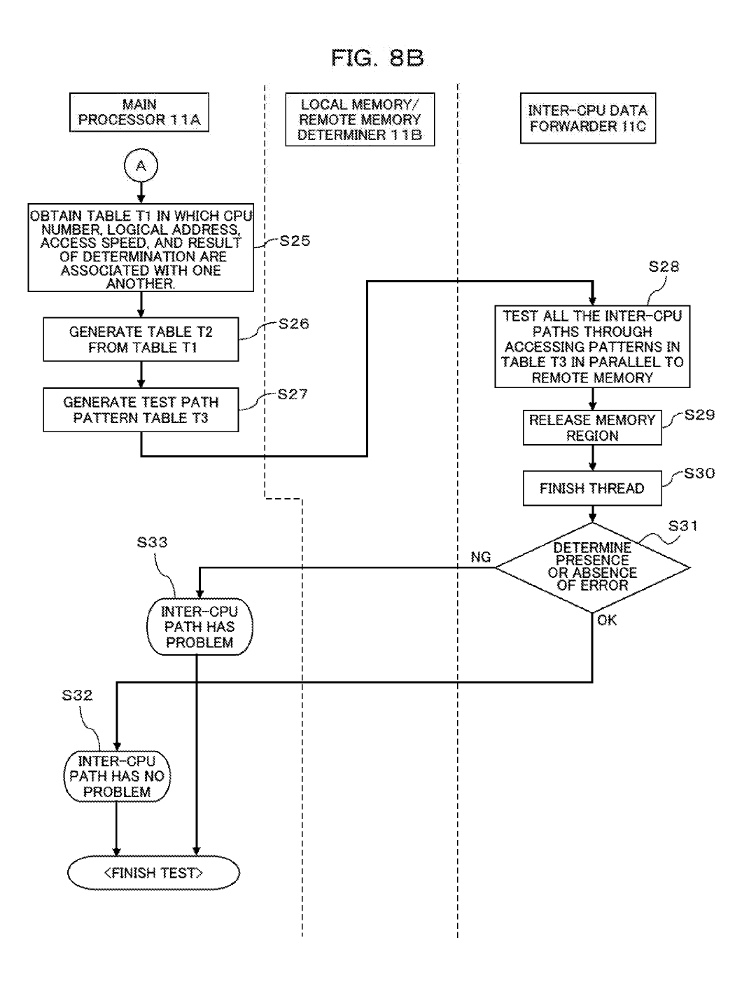

Here, description will now be made in relation to the operation of the information processing apparatus 1 (multiprocessor device 10) of the present embodiment along the flow diagram of FIGS. 8A and 8B (Steps S11-S33) with reference to FIGS. 9A-13. FIGS. 9A and 9B illustrate examples of the association table T1 of the first embodiment; FIG. 10 illustrates an example of the position table T2 of the present embodiment; and FIG. 11 illustrates an example of the test path pattern table T3 of the present embodiment.

The following description relates to the operation of the information processing apparatus 1 in cases where the multiprocessor device 10 has a four-socket CPU configuration as described above, the cache memory 11a of each CPU 11 has a size of 64 MB, and the unit block obtained by dividing the memory region has a size of 128 MB larger than the cache size. The Steps S11-S24 of FIG. 8A and Steps S25 and S26 of FIG. 8B correspond to the process of the above first step, and the Steps S27-S33 of FIG. 8B correspond to the process of the above second step.

First of all, the main processor 11A reserves a storing region for the tables T1-T3 (FIGS. 9A-11) on the local memory #0 of the smallest-number CPU #0 (Step S11 of FIG. 8A).

Thereafter, a thread is activated, being bound to a target CPU (Step S12 of FIG. 8A). For the beginning, a thread that operates only on the CPU #0 and starts the operation of the determiner 11B. Consequently, the process of Steps S12-S24 of FIG. 8A is repeated to store the logical address and the access speed of the target CPU in the association table T1. Thereby, the association table T1 illustrated in FIGS. 9A and 9B is generated.

In Step S13, the determiner 11B reserves the entire region of all the available memories 12, and divides the reserved region into unit blocks each having the predetermined size. As described above, the unit block is set to 128 MB, which is larger than the cache size of 64 MB. This can avoid cache hit during memory access for the local/remote-memory determination.

In Step S14, the determiner 11B stores a logical address of the first unit block in the association table T1 as illustrated in FIGS. 9A and 9B. Then the determiner 11B measures the access speed to the unit block corresponding to the logical address in Steps S15-S18, through a memory access made, designating the logical address.

In Step S15, the determiner 11B starts time measurement and obtains the current time.

In Step S16, the determiner 11B writes data into the unit block region specified the logical address. The data to be written is assumed to have a size of 128 MB, which is larger than the cache size of 64 MB.

In Step S17, the determiner 11B finishes the time measurement and obtains the current time.

In Step S18, the determiner 11B obtains the difference between the time obtained in Step S15 and the time obtained in Step S17 to be the access time, and calculates the access speed by dividing the predetermined size of the unit block by the obtained access time.

In Step S19, the determiner 11B stores the access speed calculated in Step S18 in the association table T1 and associates the access speed with the logical address as illustrated in FIGS. 9A and 9B.

In Step S20, the determiner 11B determines whether the process on the entire region of the memories 12 is finished. If the process on the entire region is not finished yet (No route in Step S20), the determiner 11B adds 128 MB to the logical address currently undergoing the determination (Step S21) and then the process of Steps S14-S20 is repeated.

Here, if an address obtained by adding 128 MB to the current logical address has already been determined to be a logical address corresponding to the local memory, the process of Steps S14-S19 on the logical address is skipped.

If the process on the entire region is finished (YES route in Step S20), the determiner 11B determines, on the basis of the measured access speeds, whether each memory is a local memory or remote memory (Step S22). The result of the determination is stored in the association table T1 as illustrated in FIGS. 9A and 9B.

In the determination, the determiner 11B recognizes the logical address associated with a faster access speed than any other access speeds associated with other logical addresses among the logical addresses stored in the association table T1 as the first logical address of the CPU 11, as described above. Then the determiner 11B determines that the memory 12 having a first physical address associated with the first logical address is the local memory. In contrast, the determiner 11B recognizes the other logical addresses as the second logical addresses and determines the memories 12 having second physical addresses associated with the second logical addresses to be the remote memories.

In other words, the determiner 11B classifies the access speeds into two groups, determines a logical address belonging to a group of faster access speeds to correspond to the local memory, and stores the result of the determination into the association table T1 illustrated in FIGS. 9A and 9B. In contrast, the determiner 11B determines a logical address belonging to a group of slower access speeds to correspond to a remote memory, and stores the result of the determination into the association table T1 illustrated in FIGS. 9A and 9B.

In ensuing step S23, the determiner 11B determines whether a process on all the CPUs 11 is finished. If all the CPUs 11 have not been processed yet (NO route in Step S23), the determiner 11B changes a bound CPU (target CPU) to the thread to the next CPU (Step S24) and then repeats the process of Steps S12-S20. The CPU 11 is changed in the sequence of the CPU#0, the CPU#1, the CPU#2, and the CPU#3.

At the time when the process on all the CPUs is finished (YES route in Step S23), the association table T1 illustrated in FIGS. 9A and 9B, in which a CPU number, a logical address, an access speed, and a result of determination are associated with one another, is generated on the memory #0 through the process of Steps S12-24. The main processor 11A obtains the association table T1 generated on the memory ™0 (Step S25 of FIG. 8B).

In the ensuing Step S26, the main processor 11A generates a position table T2, which specifies association of a logical address with a local memory or a remote memory, on the basis of the result of associating of a logical address with an access speed in the association table T1. In other words, the main processor 11A specifies the physical position of a memory 12 on the basis of a logical address associated with the local memory connected to or installed in each CPU 11 and generates the position table T2 illustrated in FIG. 10 which table stores the association of the logical address with the memory position.

The position table T2 illustrated in FIG. 10 stores the following associations of:
the logical address associated with the local memory of the CPU #0 to be the position of the memory #0;
the logical address associated with the local memory of the CPU #1 to be the position of the memory #1;
the logical address associated with the local memory of the CPU #2 to be the position of the memory #2; and
the logical address associated with the local memory of the CPU #3 to be the position of the memory #3.

In Step S27 of FIG. 8B, the main processor 11A generates, on the basis of the position table T2, a test path pattern table T3 that stores path patterns to be tested and that is illustrated in FIG. 11. Specifically, the test path pattern table T3 illustrated in FIG. 11 is generated through the above procedures (a1), (a2), and (a3). The test path pattern table T3 of FIG. 11 defines access manners of six path patterns P1-P6.

In the next Step S28, the inter-CPU data forwarder 11C makes accesses (Read/Write/Compare) to the remote memories through all the inter-CPU paths P1-P6 in parallel with each other with reference to the test path pattern table T3. This tests all the paths P1-P6 in parallel with one another.

For example, in testing the path (path pattern P1) between the CPU #0 and the CPU #1, a thread bound in the CPU #0 is activated and the activated thread makes an access (Read/Write/Compare) to the logical address (see the position table T2) of the memory #1.

Thereafter, the inter-CPU data forwarder 11C releases the memory region reserved in Step S13 (Step S29 of FIG. 8B) and finishes the thread (Step S30 of FIG. 8B).

Then, the result of the test carried out by the inter-CPU data forwarder 11C is referred to determine the presence of the absence of an error (Step S31 of FIG. 8B).

If an error is absent (OK route in Step S31), the main processor 11A determines that the inter-CPU path has no problem (Step S32 of FIG. 8B). In contrast, if an error is present (NG route in Step S31), the main processor 11A determines that the inter-CPU path has a problem (Step S33 of FIG. 8B).

(6) Others:

A preferred embodiment of the present invention is described as the above. The present invention should by no means be limited to particular embodiments, and can be variously changed or modified without departing from the scope of the present invention.

It is possible to specify that a memory to be accessed with reference to a logical address is a local memory or a remote memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a first calculator and a second calculator being coupled to each other via a bus, and each making a memory access, designating a logical address;
a first memory being coupled to the first calculator; and
a second memory being coupled to the second calculator and being accessed from the first calculator via the bus, wherein
the first memory determines, based on a time from issue of a request for the memory access to response to the request, whether a memory having a physical address associated with the logical address is the first memory or the second memory.

2. The information processing apparatus according to claim 1, wherein the first calculator:
divides regions of the first memory and the second memory into unit blocks of a predetermined size;
obtains access times taken for accesses to the unit blocks, the accesses being made, designating respective logical addresses associated one with each of the unit blocks;
stores the logical addresses and the access times in a first table in association with each other;
recognizes a logical address associated with a shorter access time than other access times, among the logical addresses stored in the first table, as a first logical address; and
determines a memory having a first physical address associated with the first logical address to be the first memory.

3. The information processing apparatus according to claim 1, wherein the first calculator:
divides regions of the first memory and the second memory into unit blocks of a predetermined size;
obtains access times taken for accesses to the unit blocks, the accesses being made, designating respective logical addresses associated one with each of the unit blocks;
obtains access speeds of the unit blocks based on the obtained access times and the predetermined size;
stores the logical addresses and the access speeds in a first table in association with each other;
recognizes a logical address associated with a faster access speed than other access speeds, among the logical addresses stored in the first table, as a first logical address; and
determines a memory having a first physical address associated with the first logical address to be the first memory.

4. The information processing apparatus according to claim 2, wherein the first calculator:
recognizes the other logical addresses as second logical addresses; and
determines a memory having second physical addresses associated with the second logical addresses to be the second memory.

5. The information processing apparatus according to claim 2, wherein the predetermined size is set to be larger than a size of a cache memory for the first calculator.

6. The information processing apparatus according to claim 4, wherein the first calculator:
generates a second table that specifies an association of the first logical address or the second logical address with the first memory or the second memory; and
tests a path between the first calculator and the second calculator with reference to the second table.

7. A non-transitory computer-readable recording medium having stored therein a program instructing a first calculator to execute a process comprising:
in an information processing apparatus comprising the first calculator and a second calculator being coupled to each other via a bus, and each making a memory access, designating a logical address; a first memory being coupled to the first calculator; and a second memory being coupled to the second calculator and being accessed from the first calculator via the bus,
determining based on a time from issue of a request for the memory access to response to the request, whether a memory having a physical address associated with the logical address is the first memory or the second memory.

8. The non-transitory computer-readable recording medium according to claim 7, wherein the process further comprises:
dividing regions of the first memory and the second memory into unit blocks of a predetermined size;
obtaining access times taken for accesses to the unit blocks, the accesses being made, designating respective logical addresses associated one with each of the unit blocks;
storing the logical addresses and the access times in a first table in association with each other;
recognizing a logical address associated with a shorter access time than other access times, among the logical addresses stored in the first table, as a first logical address; and
determining a memory having a first physical address associated with the first logical address to be the first memory.

9. The non-transitory computer-readable recording medium according to claim 7, wherein the process further comprises:
dividing regions of the first memory and the second memory into unit blocks of a predetermined size;
obtaining access times taken for accesses to the unit blocks, the accesses being made, designating respective logical addresses associated one with each of the unit blocks;
obtaining access speeds of the unit blocks based on the obtained access times and the predetermined size;
storing the logical addresses and the access speeds in a first table in association with each other;
recognizing a logical address associated with a faster access speed than other access speeds, among the logical addresses stored in the first table, as a first logical address; and
determining a memory having a first physical address associated with the first logical address to be the first memory.

10. The non-transitory computer-readable recording medium according to claim 8, wherein the process further comprises:
recognizing the other logical addresses as second logical addresses; and
determining a memory having second physical addresses associated with the second logical addresses to be the second memory.

11. The non-transitory computer-readable recording medium according to claim 8, wherein the predetermined size is set to be larger than a size for a cache memory of the first calculator.

12. The non-transitory computer-readable recording medium according to claim 10, wherein the process further comprises:
generating a second table that specifies an association of the first logical address or the second logical address with the first memory or the second memory; and
testing a path between the first calculator and the second calculator with reference to the second table.

13. A method for processing information comprising:
at a first calculator included in an information processing apparatus comprising the first calculator and a second calculator being coupled to each other via a bus, and each making a memory access, designating a logical address; a first memory being coupled to the first calculator; and a second memory being coupled to the second calculator and being accessed from the first calculator via the bus,
determining based on a time from issue of a request for the memory access to response to the request, whether a memory having a physical address associated with the logical address is the first memory or the second memory.

14. The method according to claim 13, further comprising:
at the first calculator,
dividing regions of the first memory and the second memory into unit blocks of a predetermined size;
obtaining access times taken for accesses to the unit blocks, the accesses being made, designating respective logical addresses associated one with each of the unit blocks;
storing the logical addresses and the access times in a first table in association with each other;
recognizing a logical address associated with a shorter access time than other access times, among the logical addresses stored in the first table, as a first logical address; and
determining a memory having a first physical address associated with the first logical address to be the first memory.

15. The method according to claim 13, further comprising:
at the first calculator,
dividing regions of the first memory and the second memory into unit blocks of a predetermined size;
obtaining access times taken for accesses to the unit blocks, the accesses being made, designating respective logical addresses associated one with each of the unit blocks;
obtaining access speeds of the unit blocks based on the obtained access times and the predetermined size;
storing the logical addresses and the access speeds in a first table in association with each other;
recognizing a logical address associated with a faster access speed than other access speeds, among the logical addresses stored in the first table, as a first logical address; and
determining a memory having a first physical address associated with the first logical address to be the first memory.

16. The method according to claim 14,
at the first calculator,
recognizing the other logical addresses as second logical addresses; and
determining a memory having second physical addresses associated with the second logical addresses to be the second memory.

17. The method according to claim 14, wherein the predetermined size is set to be larger than a size of a cache memory for the first calculator.

18. The method according to claim 16, further comprising:
at the first calculator,
generating a second table that specifies an association of the first logical address or the second logical address with the first memory or the second memory; and
testing a path between the first calculator and the second calculator with reference to the second table.
